(19) United States
(12) Patent Application Publication
(10) Pub. No.: US 2014/0354454 A1
(43) Pub. Date: Dec. 4, 2014

(54) detecting travel of a vehicle in an impermissible driving direction

(71) Applicant: Stefan Nordbruch, Kornwestheim (DE)

(72) Inventor: Stefan Nordbruch, Kornwestheim (DE)

(21) Appl. No.: 14/343,908

(22) PCT Filed: Jul. 17, 2012
(86) PCT No.: PCT/EP2012/063956

§ 371 Date: Jul. 16, 2014

(30) Foreign Application Priority Data
Sep. 13, 2011 (DE) 10 2011 082 60

(51) Int. Cl. G08G 1/056

(52) U.S. Cl. CPC G08G 1/056
USPC 340/935

(57) ABSTRACT

A method and a device for detecting travel of a vehicle in a traffic lane or on a roadway in an impermissible driving direction, at least one turnoff or exit ramp/entrance ramp being detected by checking on which side of the traffic lane or of the roadway the turnoff is detected, and the detection of the travel in the traffic lane or on the roadway in an impermissible driving direction being carried out as a function of a comparison of the detected side with the side which is expected during travel in the traffic lane or on the roadway in a permissible driving direction.

### FIELD OF THE INVENTION

The present invention is directed to a device or a method.

### BACKGROUND INFORMATION

A device is already known from EP 2164057 A which, with the aid of a camera present in the vehicle, detects traffic signs indicating that the vehicle is selecting an incorrect access ramp onto a freeway or expressway, which would result in travel in an impermissible driving direction. This information is furthermore reconciled with a navigation system and a GPS signal. In the event of wrong travel, a warning is issued to the driver, either visually or acoustically, the warning moreover being wirelessly passed on to receivers in the surroundings of the vehicle.

German patent document DE 10 2004 060 432 A1 concerns a system for detecting exit ramps, this being achieved in particular with the aid of a LIDAR system.

### SUMMARY OF THE INVENTION

The method according to the present invention having the features of the independent claim has the advantage over the related art that a system for detecting turnoffs/exit ramps/entrance ramps is used to establish whether the host vehicle is moving in the proper lane or in the proper, permissible driving direction. This is carried out by a surroundings detection system detecting that the host vehicle is passing, or will pass, a turnoff, and it is checked whether this turnoff is located on the left or on the right side of the roadway or of the traffic lane (from the perspective of the vehicle). Depending on whether left hand or right hand traffic is present and whether the viewing direction is with or against the driving direction, there is one side on which the turnoffs are usually to be expected. The examples in the present description relate to right hand traffic with a viewing direction with the driving direction; here, turnoffs are to be expected on the right side when the vehicle is moving in the permissible driving direction.

If a turnoff now occurs on the unexpected side, travel in an impermissible driving direction may be concluded (wrong-way driver).

This occurrence of exits on the right side is in particular the case when (physically) separated directional roadways exist, as is the case on freeways and expressways. In this case of separated directional roadways, it is checked on which side of the roadway traveled by the vehicle the turnoff is detected, regardless of which traffic lane of the directional roadway the vehicle is driving in.

In another case, for example on a rural road having one roadway, but two directional traffic lanes in different driving directions, it makes sense to check a turnoff from the presently traveled traffic lane. If the vehicle is driving correctly in the right traffic lane in the permissible driving direction on such a road, turnoffs from the traffic lane would occur on the right side. The oncoming lane would be located on the left side; however, a turnoff would not. However, if the vehicle is erroneously driving in the left traffic lane, turnoffs from this traffic lane (not roadway) on the left side are detectable, and thus driving in a wrong driving direction is detectable even on a normal two-lane road. If necessary, it must be taken into consideration here that this may involve permissible or desired manners of driving, such as a passing maneuver.

To prevent this, debouncing may also be introduced, as is described later. Depending on the type of road (separated/shared directional roadway), the detection of a turnoff on the unexpected side may be deemed to be a more or less valid indication that travel in an impermissible driving direction exists.

The measures listed in the dependent claims make advantageous refinements of and improvements on the method described in the independent claim possible.

It is advantageous to use the sensor system of a lane detection system (lane departure warning, lane keeping support), which must include a functionality for lane detection anyhow and is usually able to also detect turnoffs in a supplemental functionality. Such a system is frequently implemented with the aid of an optical camera, the lanes being ascertained from the image with the aid of image evaluation, or as in the case of the present invention, the turnoffs. These turnoffs may also be diverging lanes. However, these must be lanes which transition into a separate road or roadway and not, for example, a widening of the lane on the same roadway.

It is also possible to use a rear view camera which records the rear driving space (e.g., a backup camera) and which spots the turnoffs slightly later than a front view camera, namely after the vehicle has passed the turnoff. It must be noted here that the sides on which the turnoffs occur must be reversed.

It is advantageous to carry out a plausibility check with measurement results from other systems to be able to more reliably detect potential wrong-way driving. It is possible, for example, for turnoffs to occur on the seemingly wrong (unexpected) side in an optical system, despite travel in the permissible driving direction, which thus would cause a response of the system according to the present invention which is not useful. Such a case example is the exit ramps on freeways that diverge from the roadway to the left (which are few in Germany). Another error source are freeway interchanges at which traffic lanes may also correctly diverge to the left. Possible combinations of such signals from other systems are described hereafter.

The use of a digital map is advantageous, as they are available, for example, in navigation systems on board the vehicle or via data transmission links from outside the vehicle. Based on the present position of the vehicle (e.g., ascertained with the aid of a GPS signal), it is possible to extract from the data of the digital map when and where turnoffs are to be expected in the further course of travel. It is also possible to determine the side on which the turnoff is to be expected from this, and a wrong response of the system in the case of the above-mentioned few exit ramps on the left side, or freeway interchanges, is preventable. The ascertainment of whether the vehicle is driving in the wrong direction is generally not possible from the digital map alone due to the imprecision of the GPS signal. This is only possible with a further sensor system, such as the above-proposed optical camera of a lane detection system. Since it is already known based on the digital map when and where the turnoffs are to be expected, the camera or the image evaluation algorithm may be prepared accordingly to activate the turnoff detection, to expedite it, or to focus on a particular image section which is to be expected. This temporary activation may advantageously be used to save resources of the image evaluation system since an algorithm for turnoff detection need not be calculated when no turnoffs are to be expected.

It is also advantageous to carry out a plausibility check with other wrong-way driver detection systems which are based on communication or data transmission between the host vehicle and other vehicles (C2C) or between the host vehicle and infrastructure systems (C2I). Vehicle-external systems may thus provide information about potential travel in an impermissible driving direction, and the system according to the present invention in the host vehicle may check this information for plausibility, in the event the information is wrong.

It is advantageous when a light detection system is present which detects typical lights having significance regarding the travel in an (im)permissible driving direction. This applies to headlights or taillights of other vehicles, in particular those driving on the same traffic lane or the same roadway. If taillights are detectable there, travel in a permissible driving direction may be assumed. However, if headlights of other vehicles are detectable there, travel in an impermissible driving direction may be assumed. However, this system must be configured to separate or otherwise check the lights for plausibility in such a way that these are also assignable to the correct traffic lane or roadway. Such light detection systems are often implemented with an optical camera. Here, the same sensor system as that from the above-mentioned system of the turnoff detection according to the present invention, or of the lane detection system, may be used for synergy reasons. From the visibility of the headlights or taillights of other vehicles on the same traffic lane or roadway, their driving direction may be concluded and it may be checked whether or not this agrees with the same driving direction.

It is advantageous to carry out a plausibility check with a traffic sign detection system which also offers the option of detecting travel in an impermissible driving direction. This may be done, for example, in that not the front, but only the back of traffic signs is visible, or that special wrong-way driver warning signs are detected, which become visible when traveling in, or when entering, a traffic lane in an impermissible driving direction. The contours of traffic signs, if necessary also appropriate screw joints or structures on their back, may be used for the detection of backs of such signs if traffic sign symbols are absent. For detecting the traffic signs, in turn the above-described camera having a suitable image evaluation algorithm may be used.

It is advantageous to use an object detection system with which objects are detectable which, or whose movements, are typical when the host vehicle is moving in a permissible or an impermissible driving direction. In particular other vehicles are detectable as such objects, it being checked whether or not these are in oncoming traffic in relation to the host vehicle. The above-mentioned light detection system does not work in every case, for example during the day when the lights of other vehicles are turned off. Here also, the above-mentioned camera may again be used. However, it is also conceivable to use other object detection sensor systems, such as radar-based systems. In this combination, the system according to the present invention carries out a plausibility check (of exit ramps on the right side) with the results of the object detection system.

If travel in an impermissible driving direction was detected, advantageously a response of at least one system in the vehicle takes place. Presently a warning may be issued to the driver of the vehicle driving the wrong way, either visually, acoustically or haptically. Moreover, other road users may be warned (also visually, acoustically or haptically), if necessary also by car-to-car communication. Moreover, authorities or infrastructure systems may be notified, which is carried out with the aid of data transmission (C2I), for example. Moreover, active measures may also be initiated, which intervene in the driving behavior of the vehicle to end the travel in the wrong driving direction or to maneuver the vehicle into a less dangerous position. This may take place by steering interventions (e.g., automatic turnaround when the accident sensor system classifies such an option as safe) or by exiting at the next exit ramp or by driving onto the emergency lane or stopping in the emergency lane, or by switching to the correct traffic lane (if possible, on roadways having no structural separation, in particular steering back into the right lane). As a function of the design, an intervention by the driver may be allowed, or conversely the system may be configured in such a way that this is not possible.

Advantageously, debouncing may be carried out, as a result of which the detection of travel in the traffic lane or on the roadway in an impermissible driving direction does not occur until a certain number (>1) of turnoffs which occurred on the unexpected side is detected. Instead of using the straight number of turnoffs which occurred, it is also possible to use the number of turnoffs per unit of time or the traveled route/distance as a debouncing parameter.

The traffic lane (also referred to as driving lane, which is in fact an outdated technical term) denotes the surface which is available for a vehicle to drive in one direction. The traffic lane is generally identified by road markings, such as a roadway boundary and traffic lane boundary or road striping. However, different traffic lanes do not necessarily have to be identified. (source: Wikipedia)

The roadway serves as a traffic area and is composed of the individual traffic lanes and the shoulder. Vehicles may travel on it, and it forms the continuous, paved portion of the road. A road may be composed of multiple roadways, which in turn may have multiple traffic lanes. Freeways and freeway-like federal highways are configured with two so-called directional roadways, each having multiple traffic lanes and shoulders. The roadway opposing the road user is also referred to as the oncoming roadway. The two directional roadways are often separated by a structural device (for example, a median having a guardrail). (source: Wikipedia)

Presently a turnoff is a road, or a section of a road, which leads away from (diverges from) an original road. Such a road includes a roadway which diverges from another roadway and, depending on the lane marking, there is also at least one traffic lane which diverges from the original roadway or an original traffic lane. Special turnoffs, which may be considered in particular according to the present invention, are exit ramps (for example, of freeways or expressways). Due to the opposite view when traveling in an impermissible driving direction, the roadways which seemingly diverge from the same roadway and thus appear like exit ramps, or which appear to have the function of an exit, in reality are junctions for the traffic driving in the permissible direction (entering). The same applies conversely for the exit ramps, which appear to be entrance ramps. Presently the term turnoff or exit ramp may mean both here, corresponding to the logic of travel in the right or impermissible driving direction.

The side on which a turnoff is detected refers to the side which is visible looking out of the host vehicle in the forward direction. For example, exit ramps are visible on the right side of the image, i.e., to the right of the preceding same traffic lane/roadway, with a camera recording in the forward direction in the case of right hand traffic.

If the system according to the present invention were implemented with a backup camera, for example, the two sides would of course be reversed, which must be appropriately taken into consideration. It must also be considered which side is the right or wrong side for the occurrence of a turnoff.

This is in particular a function of the country; while in left hand traffic the exit ramps are to be expected on the left side, they are to be expected on the right side in right hand traffic. In the present description, the use of the terms left/right and right and wrong is based on a system using right hand traffic and a camera which is directed in the forward direction.

Exemplary embodiments of the present invention are shown in the drawings and are described in greater detail in the following description.

### BRIEF DESCRIPTION OF THE DRAWINGS

FIG. 1 shows a schematic composition of the system according to the present invention.

FIG. 2 shows the traffic situation of a vehicle on a directional roadway having two possible traffic lanes, during travel a) in the permissible driving direction, and b) in the impermissible driving direction.

FIG. 3 shows the traffic situation of a vehicle on a roadway having two separate directional traffic lanes in different directions, during travel a) in the permissible driving direction, and b) in the impermissible driving direction.

### DETAILED DESCRIPTION

FIG. 1 shows a sensor system 11, for example a video camera, in which a unit detects 12 turnoffs and which further may also determine on which side the turnoff occurs, in order to then compare 13 it to a side on which the occurrence would be expected 14 if the vehicle is moving in the permissible driving direction. Based on this, the detection of travel in the permissible driving direction 15 or impermissible driving direction 16 may take place.

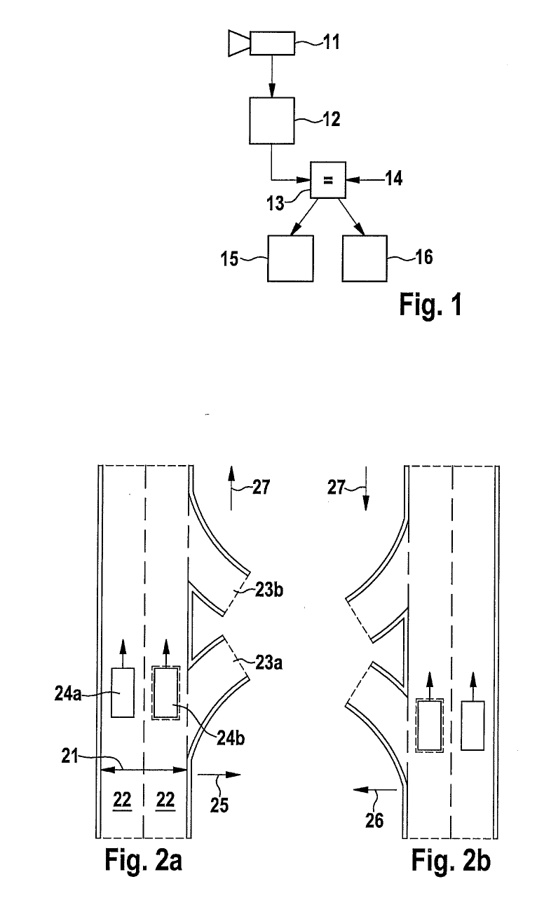

FIG. 2 shows a roadway, which is a directional roadway 21, shown here with two traffic lanes 22 for permissible travel in the same driving direction (in the illustration toward the top) 27. From this, a turnoff 23a diverges, which presently could be an exit ramp, and a junction 23b, which could be an entrance ramp. A host vehicle 24 travels in situation 24a in the left traffic lane, and in situation 24b in the right traffic lane. If according to the system of the present invention a turnoff 23 is now detected, a comparison is made as to whether this occurred on the side on which it would have been expected 25.

In Figure part b, the vehicle (shown once on the right or left traffic lane of the wrong directional roadway) drives in the impermissible driving direction, the system according to the present invention having the ability to detect the occurrence of the turnoff on the wrong side 26, which is not identical to side 25 which is to be expected. The system thus detects the travel of the host vehicle against the permissible driving direction 27.

In this exemplary embodiment, the side is relative to the roadway, and not relative to the traffic lane. The system thus detects the turnoffs, regardless of whether the vehicle is driving in the left or right traffic lane (or, if necessary, additionally present center traffic lanes).

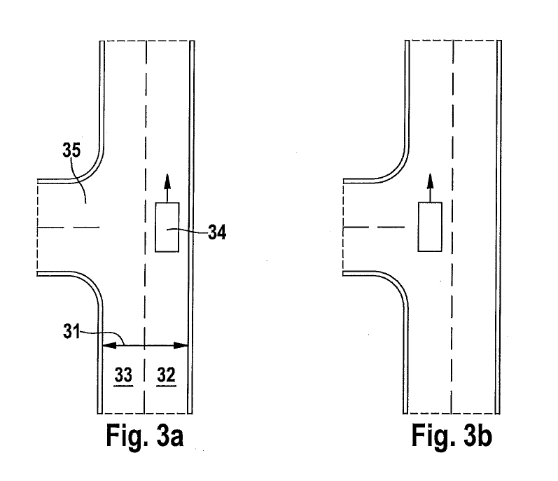

FIG. 3 shows a roadway 31 having a directional traffic lane in one direction 32 and an oncoming traffic lane 33 in the opposite driving direction, as is customary on conventional roads having one directional traffic lane in each case, for example rural roads. If vehicle 34, as is illustrated in Figure part a, is driving on the correct side in the right driving direction, the system does not detect any turnoff 35 from the same traffic lane 32 (not from the roadway as in FIG. 2), and the system would therefore also not be prompted to respond. If turnoff 35 would appear on the right side, the right side would be the permissible side, i.e., the system would classify the vehicle as driving correctly.

If the vehicle, as is illustrated in Figure part b, is driving in the left traffic lane, the system detects a road 35 diverging from this traffic lane on the unexpected side (namely on the left) and may thus prompt a response. If a turnoff would occur on the right side of the roadway, the system would not carry out an evaluation since the turnoff on the right side does not diverge from the same (left) traffic lane, but from the right traffic lane.

1-11. (canceled)

12. A method for detecting travel of a vehicle in a traffic lane or on a roadway in an impermissible driving direction, the method comprising:
detecting at least one turnoff or exit ramp/entrance ramp;
checking on which side of the traffic lane or of the roadway the turnoff is detected; and
detecting the travel in the traffic lane or on the roadway in an impermissible driving direction as a function of a comparison of the detected side with the side which is expected with travel in the traffic lane or on the roadway in a permissible driving direction.

13. The method of claim 12, wherein the turnoff/exit ramp/entrance ramp is detected with the aid of a lane detection system, which is based on visual/optical detection.

14. The method of claim 12, wherein a combination with at least one signal of at least one other system, which is able to supply information about potential travel in an impermissible driving direction, takes place to carry out or to check the detection for plausibility.

15. The method of claim 14, wherein such other system includes a digital map or a navigation system, which is suitable for predetermining the occurrence of turnoffs/exit ramps/entrance ramps.

16. The method of claim 14, wherein such other system includes a data link to other road users and/or infrastructure systems, via which information about travel or potential travel in an impermissible driving direction reaches the vehicle from outside the vehicle.

17. The method of claim 14, wherein such other system is a light detection system, which is configured to detect headlights or taillights of other vehicles in the same traffic lane or on the same roadway.

18. The method of claim 14, wherein such other system is a traffic sign detection system, which detects traffic signs or their back which occur during travel in an impermissible driving direction.

19. The method of claim 14, wherein the object detection system, which is a visual/optical one, detects whether other vehicles are in oncoming traffic with respect to the host vehicle.

20. The method of claim 12, wherein in the case of a detection that travel in an impermissible direction exists, a warning is issued to the driver of the vehicle, other road users are warned, authorities or infrastructure systems are notified and/or active measures for ending the travel in the impermissible driving direction are taken, with the aid of driver-independent interventions in the driving behavior of the vehicle.

21. The method of claim 12, wherein the evaluation of whether travel in an impermissible driving direction exists is not carried out until a certain number of turnoffs/exit ramps/entrance ramps has occurred on the unexpected side or starting at a particular number per unit of time, or starting at a particular number per distance.

22. A device for detecting a travel of a vehicle in a traffic lane or on a roadway in an impermissible driving direction, comprising:
a detecting unit to detect at least one turnoff or exit ramp/entrance ramp;
a testing unit to establish on which side in the driving direction the turnoff occurs; and
a comparison unit to carry out a detection as to whether travel in an impermissible driving direction exists as a function of a comparison of the detected side with the side which is expected during travel in the traffic lane or on the roadway in a permissible driving direction.
